(19) United States
(12) Patent Application Publication
(10) Pub. No.: US 2018/0156631 A1
(43) Pub. Date: Jun. 7, 2018

(54) NAVIGATION HANDLE FOR ATTACHMENT TO A HANDLEBAR PIPE

(71) Applicant: BOREAL BIKES INCORPORATED / LES BICYCLETTES BOREAL BOREAL INCORPORÉE, Montréal (CA)

(72) Inventor: Louis-Perpinan HUARD, Berlin (DE)

(73) Assignee: BOREAL BIKES INCORPORATED / LES BICYCLETTES BOREAL INCORPORÉE, Montréal (CA)

(21) Appl. No.: 15/575,400

(22) PCT Filed: Nov. 19, 2015
(86) PCT No.: PCT/IB2015/002523

§ 371 Date: Nov. 20, 2017

(30) Foreign Application Priority Data
May 19, 2015 (DE) 2020151025629

(51) Int. Cl. G01C 21/36; B62K 21/26; G01C 21/26; B62J 11/00; A63C 11/22

(52) U.S. Cl. CPC G01C 21/3652; B62K 21/26; G01C 21/265; B62J 2099/004; A63C 11/222; A63C 2203/18; B62J 11/00

(57) ABSTRACT

The invention relates to a navigation device, preferably for a two-wheeled vehicle, for attachment in a handlebar pipe, characterized in that the navigation device has at least the following components: at least one communication device for generating a haptic and/or acoustic ad-hoc navigation instruction for perception by a human user; and an insertion section, wherein the insertion section has a maximum external dimension, with the result that the insertion section can be introduced into a pipe. With the invention presented here, a user can be reliably navigated through traffic without visual contact.

### OBJECT OF THE INVENTION

The present invention relates to a navigation device and a navigation grip, preferably for a two-wheeler, for fastening in a handlebar tube, a navigation system for a handlebar, preferably of a two-wheeler, and a vehicle for actively or passively conveying a user, and a handlebar, preferably for a two-wheeler, and a vehicle seat, in particular for a motor vehicle, a ski pole, as well as a navigation method for the navigating of a user by means of a navigation system and a locating method for locating a navigation device.

### PRIOR ART

Navigation systems are known from prior art, in which the shortest, fastest and/or easiest route to a destination is calculated for a user depending on his current location, and the user is informed when to turn and preferably how to maneuver in traffic. Such navigation systems are also referred to in the vernacular as “GPS” according to the Global Positioning System. Most of these systems are based on a graphical user interface, frequently in connection with verbal commands. Such user interfaces are disadvantageous, specifically in traffic, because eyes, and also ears, are needed to observe the other traffic participants and the traffic signs and path of travel. This situation is intensified for the driver of a two-wheeler, in particular a bicyclist, because he is insufficiently detected by the other traffic participants, both motor vehicles as well as pedestrians, and his right of way is often violated. In order to address this, systems are sought, which do not require eye contact and do not demand full listening attention. In this connection, for example, a method from Google Navigation is known, in which the used smartphone vibrates a certain number of times to inform the user to turn. This has the disadvantage that the user must carry the smartphone close enough to their body in order to be able to clearly differentiate the vibrations from other jolts while moving and the user must learn the commands.

The disadvantages of the previously known prior art noted here are at least partially solved with the invention described below. The characteristics according to the invention result from the independent claims, for which advantageous embodiments are shown in the dependent claims. The characteristics of the claims can be combined in any technically meaningful manner, wherein for this the explanations from the below description as well as characteristics from the figures can also be used, which comprise additional designs of the invention.

### DESCRIPTION OF THE INVENTION

The invention relates to a navigation device, preferably for a two-wheeler, for fastening in a handlebar tube, characterized in that the navigation device has at least the following components:
at least one communication apparatus for generating a haptic and/or acoustic ad-hoc navigation instruction to be perceived by a human user; and
an insertion section,
   wherein the insertion section has a maximum outer dimension so that the insertion section is insertable into a tube.

The navigation device is designed to inform the user without visual contact that he should change his direction of movement or that he should stop. In this connection, the navigation device can be fastened in a tube, in a particular a handlebar tube. A corresponding handlebar is for example that of a bicycle, a motorcycle, a Segway or a mobility scooter for those with impaired mobility. But the navigation device can also be arranged in another type of tube, wherein the user is in contact with the corresponding tube or respectively tubes at least in proper operation or is positioned within listening distance.

The communication apparatus is designed to render a haptic ad-hoc navigation instruction and/or an acoustic ad-hoc navigation instruction. The haptic ad-hoc navigation instruction is preferably a vibration, which can be transmitted through the tube to the contacting body part, preferably the hand, of the user and can thus be felt by the user. Alternatively or additionally, the communication apparatus gives an acoustic ad-hoc navigation instruction, which the user can hear, without (excessively) disturbing his surroundings. The distance between the acoustic source and the user's ears is preferably less than 2 m [meters].

The ad-hoc navigation instruction is a unique instruction clearly perceivable for the user at an adequate point in time, i.e. not too early and not too late. The ad-hoc navigation instruction is temporally synchronized with the movement of the user such that the user is advised in a timely manner about a change in his direction of movement or respectively about a stop such that he can react to it without being rushed. The user is preferably advised multiple times wherein the type of ad-hoc navigation instruction preferably differs for a first instruction and a last instruction (haptic and/or audible).

The navigation device has an insertion section, by means of which the navigation device can be inserted into a tube. In an installation of the navigation device in a tube, the communication apparatus is preferably arranged in the tube. In the case of the installation in a tube, the entire navigation device, with the exception of means for removing the navigation device, is particularly preferably arranged in the tube.

For this, the insertion section has a maximum outer dimension, which is smaller at each point than the inner dimensions of a suitable tube. The inner diameter of a suitable tube is preferably designed cylindrically with a circular cross-section, but can also have a rectangular, square, polygonal or ellipsoidal cross-section and/or a cross-section that can be changed via the axial extension and can also be designed with a changeable inner diameter, for example tapering, for example in a cone-shaped manner.

According to an advantageous embodiment of the navigation device, at least one processing unit is also provided, wherein the communication apparatus can be controlled by means of the processing unit, wherein the processing unit preferably comprises a microcontroller, wherein the processing unit preferably comprises a tone generator, wherein the communication apparatus preferably comprises a loudspeaker, wherein the communication apparatus is or can be preferably arranged in an at least partially axially overlapping manner with the processing unit in the navigation device, wherein the processing unit is preferably arrangeable on a single printed circuit board.

The communication apparatus is preferably controllable by means of the processing unit, wherein the processing unit preferably receives the information for the corresponding control signals from an external device, for example a smartphone. In this connection, the processing unit is preferably completely received in the tube. The loudspeaker is for example a magnetic loudspeaker with a membrane or comprises a piezo actuator. The processing unit is preferably connected with a data connection and/or charging connection, preferably on an external printed circuit board.

According to an advantageous embodiment of the navigation device, an energy source is furthermore provided.

An energy source is an energy store, a connection to the power supply and/or an induction antenna for the wireless transmission of electrical energy.

According to an advantageous embodiment of the navigation device, the maximum outer dimension of the insertion section is designed such that the insertion section can be inserted into a cylindrical hollow space with a minimal inner diameter of less than 30 millimeters, preferably less than 22 millimeters, particularly preferably less than 16 millimeters.

The insertion section preferably has at least in some places contact points, which enable a secure fit, i.e. tight contact, of the insertion section in a cylindrical hollow space, in particular for the transmission of vibrations and/or sound waves. The inner diameter is preferably between 15 millimeters and 30 millimeters, preferably between 16 millimeters and 22 millimeters. In a preferred embodiment, at least one vibration-rigid (ring) element is arranged between the handlebar tube and the navigation device for adjustment for the respective dimensions of the respective handlebar. The (ring) element is preferably an elastic, preferably a metallic, clamp ring with low dampening properties.

According to an advantageous embodiment of the navigation device, the maximum outer dimension of the insertion section is formed by a casing cylinder with a cylinder axis and with a cylinder diameter, wherein the cylinder diameter is preferably constant along the cylinder axis.

In the inserted state of the insertion section, the cylinder axis is preferably parallel to the tube, into which the insertion section is inserted.

According to an advantageous embodiment of the navigation device, the insertion section forms a housing, and the at least one communication apparatus can be or is preferably arranged in the insertion section, and the at least one processing unit can be or is preferably arranged in the insertion section, and the energy source can be or is preferably arranged in the insertion section.

According to an advantageous embodiment of the navigation device, a fastening element is furthermore provided, by means of which the navigation device can be axially fixed in a tube in one direction, preferably in both directions, wherein the fastening element preferably forms at least one flange, which is larger than the maximum outer dimension so that the at least one flange cannot be inserted into a corresponding tube for receiving the insertion section, wherein the fastening element preferably has at least one locking device, by means of which the fastening element is at least axially fixable in cooperation with a corresponding counterlocking device, wherein the fastening element preferably has a thread, wherein the fastening element preferably has a sealing section, wherein the sealing section reduces or prevents the penetration of moisture in cooperation with a corresponding tube, which is designed to receive the insertion section.

In particular in the case of a two-wheeler, in particular in the case of a bicycle, the handlebar is exposed to shocks in a slightly damped or in an undamped manner so that a secure fastening by means of the fastening element of the navigation device is advantageous. The fixing of the navigation device is particularly preferably supported by a tight (internal) contact of the insertion section with the handlebar tube, whereby a certain frictional effect is achieved. The navigation device is preferably additionally secured by a fastening element. The fastening element is there preferably arranged on the end side, i.e. on the outside, and designed at the same time to remove the navigation device from the handlebar tube. The fastening element also preferably prevents a rotation of the navigation device around the longitudinal axis of the handlebar tube. In this connection, the locking device and the counterlocking device are preferably coordinated injection molded elements, which can be interconnected elastically (easily releasable by hand). The sealing section is preferably formed by one or more sealing lips, which abut in the inserted state on the circumferential inside against the handlebar tube.

According to an advantageous embodiment of the navigation device, a cap section is furthermore provided, which connects to the insertion section, wherein the cap section preferably tapers on the outside with respect to the insertion section, wherein the cap section can preferably be detachably fastened directly to the insertion section, wherein the cap section can preferably be screwed to the insertion section, wherein the cap section can preferably be locked to the insertion section, wherein the cap section preferably has a knurl.

The insertion section is preferably designed such that the fit clearance between the insertion section and the correspondingly designed tube is small. Insertion might then be difficult. This is facilitated by a cap section tapered on the outside, in that the fit clearance is slightly greater during the cap-side insertion. The knurl facilitates the removal of the cap section by hand without an additional tool.

According to an advantageous embodiment of the navigation device, the navigation device also has at least one data connection for the processing unit, wherein at least one of the data connections preferably comprises an induction coil.

The at least one data connection is designed to transmit data from an external device, for example a smartphone, to the processing unit. With an induction coil, the data can be passed wirelessly from outside the tube.

According to an advantageous embodiment of the navigation device, the energy source comprises an energy store, which comprises at least one battery, wherein the communication apparatus can be or is preferably arranged in the navigation device at least partially axially overlapping with the energy store.

According to an advantageous embodiment of the navigation device, the energy source comprises an at least partially rechargeable energy store and the navigation device also has at least one charging connection for charging the rechargeable energy store, wherein the communication apparatus can be or is preferably arranged at least partially axially overlapping with the energy store in the navigation device, wherein at least one of the charging connections particularly preferably comprises an induction coil.

The rechargeable energy store is a battery, particularly preferably a lithium-ion battery. The charging connection is connected with the battery directly or via the processing unit. The battery preferably comprises a separate sensor system, which monitors the charged state of the battery and preferably communicates with the processing unit or directly with an external device, for example in the Smartphone, so that a favorable charging time and/or a necessary charging time are displayed to the user.

According to an advantageous embodiment of the navigation device, at least one of the charging connection is also a data connection for the processing unit, wherein preferably at least one of the charging connections and/or at least one of the data connections is a USB connector, preferably a mini-USB connector and/or a micro-USB connector and/or a USB Type-C connector.

According to an advantageous embodiment of the navigation device, the processing unit comprises an antenna for receiving data, wherein the processing unit preferably comprises at least one antenna for sending data, wherein one antenna is designed for transmitting and one for receiving data by means of a single transceiver antenna, wherein at least one of the antennas is preferably designed for a frequency range between 2.4 gigahertz and 2.5 gigahertz, preferably for 2.402 GHz to 2.480 GHz and/or for 2.4 GHz to 2.4835 GHz, wherein at least one of the antennas is designed for a frequency range between 5 gigahertz and 6 gigahertz, preferably for 5.17 GHz to 5.727 GHz.

The data is particularly preferably transmitted wirelessly for adequate output of the ad-hoc navigation instructions by means of a standardized transmission process, wherein the free (worldwide) frequency ranges are preferably used for the carrier wave. In this connection, the now widespread and user-friendly Bluetooth® standard or the Wi-Fi™ standard are preferably used for the wireless transmission. In particular, a transmission process is preferred, which is, on one hand, user-friendly and, on the other hand, can be transmitted securely and failure-free over a distance of approximately 2 m [meters]. Other frequency ranges, which are not license-free, and transmission processes can also generally be used.

According to an advantageous embodiment of the navigation device, the communication apparatus comprises a vibration motor, wherein the vibration motor preferably comprises a rotatable eccentric mass and/or the vibration motor preferably comprises a mass that can be moved back and forth linearly.

According to an advantageous embodiment of the navigation device, the processing unit comprises a position capturing unit.

The position capturing unit hereby preferably comprises a GPS antenna (or similar systems) and/or another position capturing apparatus, for example also a cellular antenna for triangulation and/or an acceleration sensor for mathematically integrative capturing of the traveled route. Moreover, the position capturing unit preferably comprises a corresponding computing module for determining the current position.

According to a further aspect of the invention, a navigation grip, preferably for a two-wheeler, for fastening on a handlebar tube is suggested, which is characterized above all in that the navigation grip has at least the following components:
a navigation device according to an embodiment according to the above description, which can be inserted with the insertion section laterally into a handlebar tube;
a grip section for the secure, and preferably comfortable, gripping of a handlebar tube by hand, wherein the grip section can be guided onto the respective handlebar tube, wherein preferably a vibration of the communication apparatus of the navigation device can be felt by a hand of a user when gripping the grip section.

The grip section is preferably a separate component, with which the navigation device can be releasably connected. The grip section preferably remains permanently on the handlebar tube after a one-time installation, i.e. the grip section cannot be removed (without damage) or it can only be removed using a special tool, for example by means of a safety key and/or by means of an extracting tool. The grip section preferably corresponds, at least with respect to its grip properties and fastening methods on the handlebar tube, with a standardized, previously known grip.

According to an advantageous embodiment of the navigation grip, a connection element is also provided, by means of which the navigation device is at least axially fixable with the handlebar tube, wherein the connection element is preferably designed to at least axially fix the grip section with the handlebar tube on the end side, wherein a ring element is preferably also provided, which is arranged on the grip section opposite the connection element and by means of which the grip section is at least axially fixable with the handlebar tube.

The connection element forms an adapter for the navigation device for the axial fixing, preferably corresponding with a fastening element of the navigation device. For this, the connection element is preferably arranged on the handlebar tube on the end side, i.e. on the outside. The connection element is also preferably designed for fixing the grip section. In contrast, the ring element is preferably solely designed to fasten the grip section. The connection element and/or the ring element are also preferably designed to prevent a twisting of the grip section.

According to a further aspect of the invention, a navigation system for a handlebar, preferably for a handlebar of a two-wheeler is suggested, which is characterized above all in that the navigation system has at least the following components:
a left communication means comprising a navigation grip according to an embodiment according to the above description or comprising a navigation device according to an embodiment according to the above description;
a right communication means comprising a navigation grip according to an embodiment according to the above description or comprising a navigation device according to an embodiment according to the above description; and
a position capturing unit and a user interface, preferably in a smartphone, wherein a navigation task can be entered by a user via the user interface so that the position capturing unit outputs a navigation route, and wherein an ad-hoc navigation instruction that is clear in terms of the side can be output to the user by means of the communication means according to this navigation route.

A user preferably enters on his smartphone, which is connected (wirelessly) with the communication means to transfer data, a destination, wherein the smartphone captures and continuously monitors his (own) current position. The smartphone calculates a route to the destination, and, instead of, or in addition to, a verbal and/or screen-based display, the user is informed about a necessary change in the direction of movement (taking the street configuration into consideration, if applicable) by means of the communication means. Thus, the user does not need to divert his (visual) attention from the traffic situation.

According to an advantageous embodiment of the navigation system, the left communication means can be triggered to output a haptic and/or acoustic ad-hoc navigation instruction when the user should turn to the left, and/or the right communication means can be triggered to output a haptic and/or acoustic ad-hoc navigation instruction when the user should turn to the right.

All other potential combinations are also possible, wherein an intuitively comprehensible instruction is useful for most applications.

According to a further aspect of the invention, a vehicle for actively or passively conveying a user is suggested, which is characterized above all in that the vehicle has at least the following components:
a left communication means comprising a navigation grip according to an embodiment according to the above description or a navigation system according to an embodiment according to the above description or comprising a navigation device according to an embodiment according to the above description;
a right communication means comprising a navigation grip according to an embodiment according to the above description or a navigation system according to an embodiment according to the above description or comprising a navigation device according to an embodiment according to the above description; and
a position capturing unit and a user interface, preferably in a smartphone, wherein a navigation task can be entered by a user via the user interface so that the position capturing unit outputs a navigation route, and wherein an ad-hoc navigation instruction that is clear in terms of the side can be output to the user by means of the communication means according to this navigation route.

Such a vehicle is for example a passenger vehicle, a motorcycle, a mobility scooter, a Segway or the like for passively conveying a user or a bicycle, a scooter or the like for actively conveying a user. An external energy store is preferably used for the navigation device. An external (joint) processing unit is preferably used.

According to a further aspect of the invention, a handlebar, preferably for a two-wheeler, is suggested, which is characterized above all in that the handlebar has at least the following components:
a left grip for a left hand of a user;
a right grip for a right hand of a user;
an energy source;
a processing unit;
a left communication means for the left grip;
a right communication means for the right grip;
   wherein the two communication means are each designed to output a haptic and/or acoustic ad-hoc navigation instruction for the true-to-side perception by a human user, wherein the communication apparatus is controllable by means of the processing unit, wherein the processing unit is designed to process data signals based on a navigation route, and wherein a haptic and/or acoustic ad-hoc navigation instruction that is clear in terms of the side can be output to the user by means of the communication means according to this navigation route, wherein the communication means are each preferably a navigation device according to an embodiment according to the above description.

Such a handlebar is for example a handlebar of a motorcycle, a bicycle, a mobility scooter, a Segway or the like. An external energy store is preferably used. An external (joint) processing unit is preferably used.

According to a further aspect of the invention, a ski pole is suggested, which is characterized above all in that the ski pole has at least the following components:
a grip for a hand of a user;
an energy source;
a processing unit;
a communication means for the grip;
   wherein the communication means is designed to output a haptic and/or acoustic ad-hoc navigation instruction for the true-to-side perception by a human user, wherein the communication apparatus is controllable by means of the processing unit, wherein the processing unit is designed to process data signals based on a navigation route, and wherein a haptic and/or acoustic ad-hoc navigation instruction that is clear in terms of the side can be output to the user by means of the communication means according to this navigation route, wherein the communication means is preferably a navigation device according to an embodiment according to the above description.

According to a further aspect of the invention, a vehicle seat, in particular for a motor vehicle, is suggested, which is characterized above all in that the vehicle seat has at least the following components:
an energy source;
a processing unit;
a left communication means;
a right communication means;
   wherein the two communication means are each designed to output a haptic and/or acoustic ad-hoc navigation instruction for the true-to-side perception by a human user, wherein the communication apparatus is controllable by means of the processing unit, wherein the processing unit is designed to process data signals based on a navigation route, and wherein a haptic and/or acoustic ad-hoc navigation instruction that is clear in terms of the side can be output to the user by means of the communication means according to this navigation route.

The navigation device is preferably accommodated in a tube, or respectively in two tubes, of the vehicle seat construction so that the safety of the vehicle occupants is hereby ensured in the event of a crash without substantial calculations. In this connection, the ad-hoc navigation instruction is adjusted for the potentially increased distance and/or a damped contact path to the user (for example on the seat cushion). But a larger (external) energy store is usually also available here.

According to a further aspect of the invention, a navigation method for the navigating of a user by means of a navigation system according to an embodiment according to the above description or by means of a vehicle according to an embodiment according to the above description or by means of a handlebar according to an embodiment according to the above description with a position capturing unit or by means of two ski poles according to an embodiment according to the above description with a position capturing unit or by means of a vehicle seat according to an embodiment according to the above description with a position capturing device is suggested, wherein the navigation method comprises at least the following steps:
input of a navigation task into the user interface;
calculation of a navigation route;
output of an ad-hoc control value to the navigation device. The navigation method is characterized above all in that the navigation method also comprises at least the following step:
output of an ad-hoc navigation instruction registrable by the user without visual contact by means of one of the two communication apparatuses when the user should change his direction of movement, preferably by means of the vibration of the left communication apparatus when the user should turn to the left, and by means of the vibration of the right communication apparatus when the user should turn to the right, wherein both communication apparatuses preferably output an ad-hoc navigation instruction registrable by the user without visual contact when the user should stop.

In this connection, the communication apparatus, or respectively the navigation device, is only used as an output unit and interface to the user. Alternatively, an independent calculation takes place in a processing unit of the navigation device, wherein the route specification is then preferably (only) provided by the external position capturing unit.

In addition to the aforementioned options, all other potential combinations are also possible for the rendering of an ad-hoc navigation instruction, wherein an intuitively comprehensible instruction is useful for most applications.

According to an advantageous embodiment of the navigation method, the navigation task comprises the cohesion of a group, wherein the group preferably comprises only those members, each of which
operate a left communication means, which comprises a navigation grip according to an embodiment according to the above description or a navigation device according to an embodiment according to the above description; and
operate a right communication means, which comprises a navigation grip according to an embodiment according to the above description or a navigation device according to an embodiment according to the above description,
   wherein, when a predetermined maximum distance is exceeded by at least one member of the group, the respective other members of the group receive an ad-hoc stop instruction.

An ad-hoc stop instruction is then alternatively or additionally output when the user is losing the right way, i.e. deviates from the route specification. It is frequently easier, in particular for a bicyclist, to stop and ride back a short distance rather than make a U-turn. For example, both navigation devices vibrate in the case of an ad-hoc stop instruction.

According to a further aspect of the invention, a locating method for locating a navigation device according to an embodiment according to the above description or a vehicle according to the above description or by means of a handlebar according to an embodiment according to the above description or by means of a ski pole according to the above description is suggested, wherein the locating method comprises at least the following step:
entry of a search query into a user interface for at least one navigation device. The locating method is characterized above all in that the locating method also comprises at least the following steps:
output of the position of the navigation device on a screen and/or triggering of an acoustic signal by the communication apparatus, wherein the acoustic signal can preferably be heard over a distance of at least 5 meters, wherein the acoustic signal is preferably individually changeable before and/or during the locating method by the user and/or per factory setting.

This process is advantageous in particular for parents with their children or guided sightseeing tours.

### DESCRIPTION OF FIGURES

The invention described above is explained in detail below against the pertinent technical background in reference to the associated drawings, which show preferred designs. The invention is in no way restricted by the purely schematic drawings, whereupon it should be noted that the drawings are not true to size and are not suitable to define proportions. The drawings show the following

FIG. 1: an exploded representation of a navigation device;

FIG. 2: a spatial representation of a navigation device;

FIG. 3: an exploded representation of a navigation system;

FIG. 4: a vehicle with two communication means.

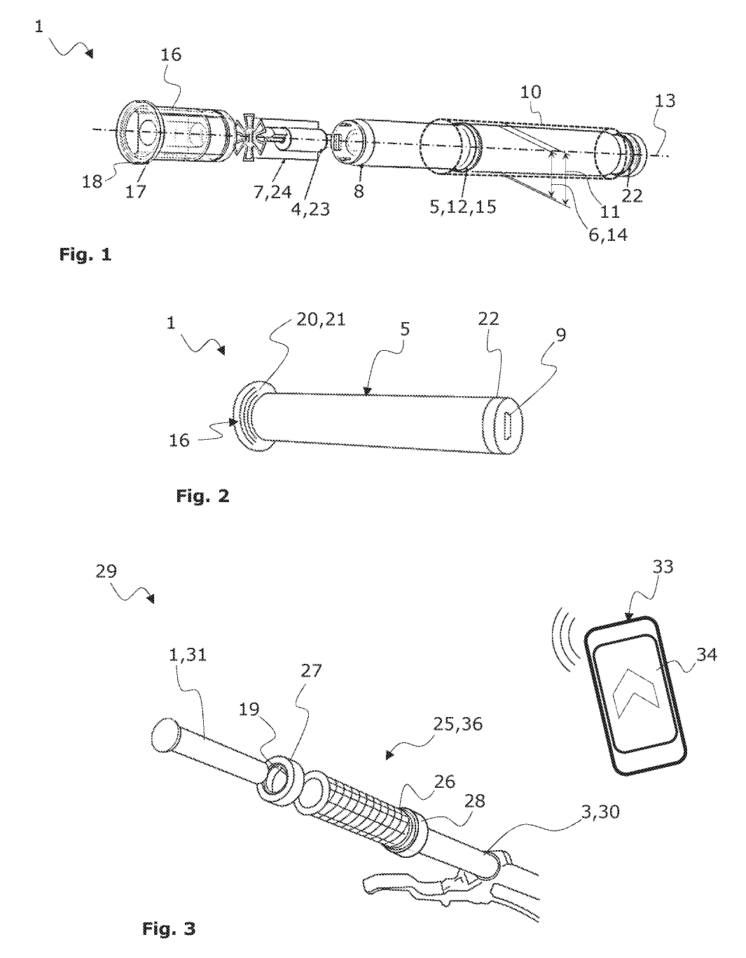

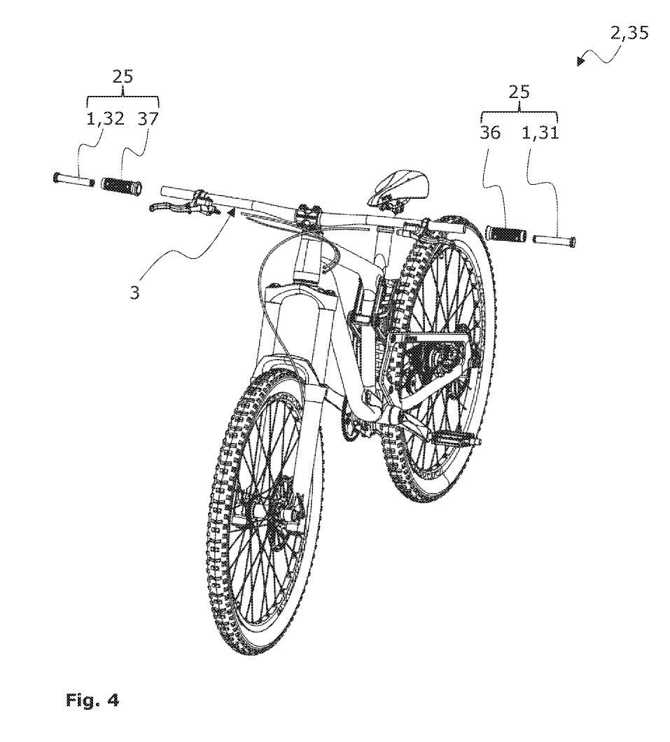

FIG. 1 shows as an example a navigation device 1 in an exploded representation. The navigation device 1 comprises a communication apparatus 4, which here comprises a vibration motor 23, for example an eccentric motor. The communication apparatus 4 is controlled by a processing unit 7, which is arranged here on a single printed circuit board 24, for communication with a user. The energy source here is formed by an energy store 8, which is (re-) chargeable via a charging connection 9 (see FIG. 2), wherein the charging connection 9 here is designed as a mini-USB plug and is preferably simultaneously a data connection. These elements are all arranged in a housing 15, which here together with a casing cylinder forms the insertion section 5 so that the main part of the navigation device 1 is (completely) arrangeable in a handlebar tube 3 (see FIG. 3 or FIG. 4). The casing cylinder 12 hereby has a maximum outer dimension 6, here a cylinder diameter 14 so that the insertion section 5 is insertable, preferably with an exact fit, into a cylindrical hollow space 10 with a minimum inner diameter 11. The cylindrical hollow space 10 corresponds with the inner dimensions of a handlebar tube 3, in which the insertion section 5 is insertable. The insertion section 5 is preferably designed such that it fits as tightly as possible, and preferably over as large an area as possible, in the handlebar tube 3. A fastening element 16 for the axial fixing of the navigation device 1 is provided, wherein the fastening element 16 in this embodiment is a flange 17. The flange 17 restricts a maximum insertion path starting from an end side of the handlebar tube 3 and thus axially fixes the navigation device 1 at least in one direction. Additionally, the fastening element 16 here has a locking device 18, which axially fixes the navigation device 1 also in the other direction with a corresponding counterlocking device 19 (see FIG. 3) and preferably also prevents a rotation of the navigation device 1 around the cylinder axis 13. The fastening element 16 is preferably designed such that the navigation device 1 can be easily pulled out again. In this preferred embodiment, the fastening element 16 is permanently fixed and cannot be removed in a non-destructive manner, for example glued, with the housing 15 of the navigation device 1. A removal of the components arranged in the housing 15 is (in this case only) possible on the axially opposite side through an opening, wherein the opening here can be closed by a cap section 22, here screwed to the housing 15. According to a further aspect, the cap section 22 tapers in the direction away from the housing 15 so that the insertion section 5 is easier to insert into the cylindrical hollow space 10.

FIG. 2 shows an assembled navigation device 1, which is preferably structured as shown in FIG. 1. In a preferred embodiment, the fastening element 16 here also has a sealing section 21, by means of which the insertion section 5 is (better) protected from penetrating moisture in the inserted state. In this connection, the sealing section 21 is preferably designed as the thread 20, which is also designed for the axial fastening of the navigation device 1 in a handlebar tube 3 (see FIG. 3 or FIG. 4). For the easier operability without a tool, the cap section 22 preferably has a knurl.

FIG. 3 shows a navigation system 29 with a navigation grip 25 and a position capturing unit 33 in a (partially) exploded representation. The navigation device 1 of the navigation grip 25 preferably corresponds with the navigation device 1 shown in FIG. 1 or in FIG. 2. A left grip 36 with a left communications means 31, namely of the navigation device 1, is shown by itself in this representation. The left communication means 31 is insertable into the handlebar tube 3 of the handlebar 30, for example of a bicycle (see FIG. 4). A grip section 26 can be guided onto the handlebar tube 3, which is fixable axially, and preferably also in the circumferential direction, in this case by means of the connection element 27 (here a clamp ring) on the handlebar tube 3. In this connection, the connection element 27 simultaneously serves to fix the (left) communication means 31 and preferably has for this a counterlocking device 19, which corresponds with the locking device 18, as shown in FIG. 1. In this example, the navigation device 1 is connected wirelessly, for example by means of Bluetooth®, with an (external) position capturing apparatus 33, for example a smartphone, wherein the user can enter a navigation task via the user interface. The position capturing apparatus 33 sends the calculated route or preferably an ad-hoc signal to the navigation devices 1, which then output an ad-hoc navigation instruction that is clear in terms of the side, for example a vibration. This vibration can be felt by the user via the gripped grip section 26.

FIG. 4 shows a vehicle 35, here a two-wheeler 2, specifically a bicycle, with a left communication means 31 and a right communication means 32, each of which are formed here by a navigation device 1, preferably as shown in the previous figures. Together with a left grip 36 or respectively a right grip 37, the left communication means 31 and the right communication means 32 each form a navigation grip 25. For example, if the right communication means 32 vibrates, the user notices this while riding the two-wheeler and then knows that he should turn for example (at the next opportunity) to the right.

With the invention shown here, a user can safely navigate through traffic without visual contact.

Reference List

| | |
|---|---|
| 1 | Navigation device |
| 2 | Two-wheeler |
| 3 | Handlebar tube |
| 4 | Communication apparatus |
| 5 | Insertion section |
| 6 | Maximum outer dimension |
| 7 | Processing unit |
| 8 | Energy store |
| 9 | Charging connection |
| 10 | Cylindrical hollow space |
| 11 | Minimal inner diameter |
| 12 | Casing cylinder |
| 13 | Cylinder axis |
| 14 | Cylinder diameter |
| 15 | Housing |
| 16 | Fastening element |
| 17 | Flange |
| 18 | Locking device |
| 19 | Counterlocking device |
| 20 | Thread |
| 21 | Sealing section |
| 22 | Cap section |
| 23 | Vibration motor |
| 24 | Printed circuit board |
| 25 | Navigation grip |
| 26 | Grip section |
| 27 | Connection element |
| 28 | Ring element |
| 29 | Navigation system |
| 30 | Handlebar |
| 31 | Left communication means |
| 32 | Right communication means |
| 33 | Positioning capturing unit |
| 34 | User interface |
| 35 | Vehicle |
| 36 | Left grip |
| 37 | Right grip |

1. A navigation device (1), preferably for a two-wheeler (2), for fastening in a handlebar tube (3), characterized in that the navigation device (1) has at least the following components:
at least one communication apparatus (4) for generating a haptic ad-hoc navigation instruction to be perceived by a human user; and/or at least one communication apparatus (4) for generating an acoustic ad-hoc navigation instruction to be perceived by a human user, and
an insertion section (5),
wherein the insertion section (5) has a maximum outer dimension (6) so that the insertion section (5) is insertable into a tube (3).

2.-3. (canceled)

4. The navigation device (1) according to claim 1, characterized in that at least one processing unit (7) is furthermore provided, wherein the communication apparatus (4) is controllable by means of the processing unit (7).

5.-12. (canceled)

13. The navigation device (1) according to claim 1, characterized in that a fastening element (16) is also provided, by means of which the navigation device (1) is axially fixable in one direction in a tube (3).

14. The navigation device (1) according to claim 13, characterized in that the navigation device (1) is axially fixable in both directions in a tube (3) by means of the fastening element (16).

15.-18. (canceled)

19. The navigation device (1) according to claim 1, characterized in that a cap section (22) is also provided, which connects to the insertion section (5).

20.-33. (canceled)

34. The navigation device (1) according to claim 1, characterized in that an energy source (8, 9) is furthermore provided, by means of which the processing unit (7) and preferably the communication apparatus (4) can be powered, wherein the energy source (8, 9) comprises an at least partially rechargeable energy store (8) and the navigation device (1) also has at least one charging connection (9) for charging the rechargeable energy store (8), and that at least one of the charging connections (9) and/or at least one of the data connections (9) comprises an induction coil.

35. (canceled)

36. The navigation device (1) according to claim 4, characterized in that the processing unit (7) comprises a tone generator, in particular a loudspeaker.

37. The navigation device (1) according to claim 4, characterized in that the processing unit (7) comprises an antenna for receiving data, and/or at least one antenna for transmitting data, wherein at least one of the antennas is designed for a frequency range between 2.4 gigahertz and 2.5 gigahertz, preferably for 2.402 GHz to 2.480 GHz and/or for 2.4 GHz to 2.4835 GHz, and/or is designed for a frequency range between 5 gigahertz and 6 gigahertz, preferably for 5.17 GHz to 5.727 GHz.

38.-41. (canceled)

42. The navigation device (1) according to claim 1, characterized in that the communication apparatus (4) comprises a vibration motor (23).

43.-45. (canceled)

46. The navigation device (1) according to claim 4, characterized in that the processing unit (7) comprises a position capturing unit.

47.-48. (canceled)

49. A navigation grip (25), preferably for a two-wheeler (2), for fastening on a handlebar tube (3), characterized in that the navigation grip (25) has at least the following components:
a navigation device (1) according to claim 1, which can be inserted with the insertion section (5) laterally into a handlebar tube (3);
a grip section (26) for the secure, and preferably comfortable, gripping of a handlebar tube (3) by hand, wherein the grip section (26) can be guided onto the respective handlebar tube (3).

50.-53. (canceled)

54. A navigation system (29) for a handlebar (30), preferably of a two-wheeler (2), characterized in that the navigation system (29) has at least the following components:
a left communication means (31) comprising a navigation grip (25) according to claim 49;
a right communication means (32) comprising a navigation grip (25) according to claim 49; and
a position capturing unit (33) and a user interface (34), preferably in a smartphone, wherein a navigation task can be entered by a user via the user interface (34) so that the position capturing unit (33) outputs a navigation route, and wherein an ad-hoc navigation instruction that is clear in terms of the side can be output to the user by means of the communication means (31, 32) according to this navigation route.

55.-58. (canceled)

59. A vehicle (35) for actively or passively conveying a user, characterized in that the vehicle (35) has at least the following components:
a left communication means (31) comprising a navigation grip (25) according to claim 49;
a right communication means (32) comprising a navigation grip (25) according to claim 49; and
a position capturing unit (33) and a user interface (34), preferably in a smartphone, wherein a navigation task can be entered by a user via the user interface (34), so that the position capturing unit (33) outputs a navigation route, and wherein an ad-hoc navigation instruction that is clear in terms of the side can be output to the user by means of the communication means (31, 32) according to this navigation route.

60. A handlebar (30), preferably for a two-wheeler (2), characterized in that the handlebar (30) has at least the following components:
a left grip (36) for a left hand of a user;
a right grip (37) for a right hand of a user;
an energy source (8, 9);
a processing unit (7);
a left communication means (31) for the left grip (36);
a right communication means (32) for the right grip (37);
wherein the communication means (31, 32) are each a navigation device (1) according to claim 1,
wherein the two communication means (31, 32) are each designed to output a haptic ad-hoc navigation instruction for the true-to-side perception by a human user, wherein the communication apparatus (4) is controllable by means of the processing unit (7), wherein the processing unit (7) is designed to process data signals based on a navigation route, and wherein a haptic ad-hoc navigation instruction that is clear in terms of the side can be output to the user by means of the communication means (31, 32) according to this navigation route,
or
wherein the two communication means (31, 32) are each designed to output an acoustic ad-hoc navigation instruction for the true-to-side perception by a human user, wherein the communication apparatus (4) is controllable by means of the processing unit (7), wherein the processing unit (7) is designed to process data signals based on a navigation route, and wherein an acoustic ad-hoc navigation instruction that is clear in terms of the side can be output to the user by means of the communication means (31, 32) according to this navigation route.

61.-63. (canceled)

64. A ski pole, characterized in that the ski pole has at least the following components:
a grip (36, 37) for a hand of a user;
an energy source (8, 9);
a processing unit (7);
a communication means (31,32) for the grip (36, 37);
wherein the communication means (31, 32) is a navigation device (1) according to claim 1,
wherein the communication means (31, 32) is designed to output a haptic ad-hoc navigation instruction for the true-to-side perception by a human user, wherein the communication apparatus (4) is controllable by means of the processing unit (7), wherein the processing unit (7) is designed to process data signals based on a navigation route, and wherein a haptic ad-hoc navigation instruction that is clear in terms of the side can be output to the user by means of the communication means (31, 32) according to this navigation route, or
wherein the communication means (31, 32) is designed to output an acoustic ad-hoc navigation instruction for the true-to-side perception by a human user, wherein the communication apparatus (4) is controllable by means of the processing unit (7), wherein the processing unit (7) is designed to process data signals based on a navigation route, and wherein an acoustic ad-hoc navigation instruction that is clear in terms of the side can be output to the user by means of the communication means (31, 32) according to this navigation route.

65.-67. (canceled)

68. A vehicle seat, in particular for a motor vehicle (35), characterized in that the vehicle seat has at least the following components:
an energy source (8, 9);
a processing unit (7);
a left communication means (31);
a right communication means (32);
wherein the two communication means (31, 32) are each designed to output a haptic ad-hoc navigation instruction for the true-to-side perception by a human user, wherein the communication apparatus (4) is controllable by means of the processing unit (7), wherein the processing unit (7) is designed to process data signals based on a navigation route, and wherein a haptic ad-hoc navigation instruction that is clear in terms of the side can be output to the user by means of the communication means (31, 32) according to this navigation route, or
wherein the two communication means (31, 32) are each designed to output an acoustic navigation instruction for the true-to-side perception by a human user, wherein the communication apparatus (4) is controllable by means of the processing unit (7), wherein the processing unit (7) is designed to process data signals based on a navigation route, and wherein an acoustic ad-hoc navigation instruction that is clear in terms of the side can be output to the user by means of the communication means (31, 32) according to this navigation route.

69.-70. (canceled)

71. A navigation method for the navigating of a user by means of a navigation system (29) according to claim 54, wherein the navigation method comprises at least the following steps:
input of a navigation task into the user interface (34);
calculation of a navigation route;
output of an ad-hoc control value to the navigation device (1),
characterized in that the navigation method also comprises at least the following step:
output of an ad-hoc navigation instruction registrable by the user without visual contact by means of one of the two communication apparatuses (4) when the user should change his direction of movement, preferably by means of the vibration of the left communication apparatus (4) when the user should turn to the left, and by means of the vibration of the right communication apparatus (4) when the user should turn to the right.

72. The navigation method according to claim 71, characterized in that both communication apparatuses (4) output an ad-hoc navigation instruction registrable by the user without visual contact when the user should stop.

73. The navigation method according to claim 71, characterized in that the navigation task comprises the cohesion of a group, wherein the group preferably comprises only those members, each of which
operate a left communication means (31), which comprises the navigation device (1); and
operate a right communication means (32), which comprises the navigation device (1),
wherein, when a predetermined maximum distance is exceeded by at least one member of the group, the respective other members of the group receive an ad-hoc stop instruction.

74. A locating method for locating a navigation device (1) according to claim 1, wherein the locating method comprises at least the following step:
entry of a search query into a user interface (34) for at least one navigation device (1);
characterized in that the locating method also comprises at least the following steps:
output of the position of the navigation device (1) on a screen and/or triggering of an acoustic signal by the communication apparatus (4), wherein the acoustic signal can preferably be heard over a distance of at least 5 meters, wherein the acoustic signal is preferably individually changeable before and/or during the locating method by the user and/or per factory setting.
